(19) United States
(12) Patent Application Publication
(10) Pub. No.: US 2005/0286554 A1
(43) Pub. Date: Dec. 29, 2005

(54) INTEGRATED CODEC APPARATUS AND METHOD THEREOF

(76) Inventors: Chih-Wei Teng, Taipei City (TW); Chih-Chiang Shen, Taipei City (TW)

Correspondence Address: NORTH AMERICA INTELLECTUAL PROPERTY CORPORATION, P.O. BOX 506, MERRIFIELD, VA, 22116, US

(21) Appl. No.: 10/908,020

(22) Filed: Apr. 25, 2005

(30) Foreign Application Priority Data
May 6, 2004 (TW) 093112755

(51) Int. Cl. H04L 12/66

(52) U.S. Cl. 370/466; 370/395.5

(57) ABSTRACT

An integrated coder/decoder (CODEC) apparatus converts incoming data into outgoing data. The integrated CODEC apparatus includes a plurality of CODEC modules. Each CODEC module is for encoding the incoming data to produce the outgoing data or for decoding the incoming data to produce the outgoing data. A processing unit is electrically coupled to the plurality of CODEC modules for controlling at least one of the CODEC modules to convert the incoming data into the outgoing data according to an original data format of the incoming data or according to a target data format of the outgoing data.

### BACKGROUND OF INVENTION

1. Field of the Invention

The invention relates to an integrated coder/decoder (CODEC) apparatus, and more particularly, to an integrated CODEC apparatus and method for controlling a CODEC module according to the original data format of incoming data or according to a target data format of outgoing data.

2. Description of the Prior Art

With the continued development in the field of multimedia, new advances and usages are producing different user requirements. Because of this, the Moving Picture Experts Group (MPEG) of the International Standards organization (ISO) has established video compression standards to provide a standard data interface for apparatuses with different formats. Following these standards, each company can individually produce their own encoder and decoder. These CODECs (coder/decoder) with different formats provide appropriate compression ratios for data processing according to different user requirements. For example, for higher transmitted data bandwidths, a technique having a smaller compression ratio such as MPEG-1 can be used. For lower transmitted data bandwidths, for example transmitted video passing through a cell phone handset, a technique having a higher compression ratio such as MPEG-4 can be used. Additionally, because of this plurality of devices using different formats, it is often required to convert multimedia data being compressed with a first data format to multimedia data being compressed with a second data format.

However, prior art CODEC apparatuses are implemented using integrated circuits (ICs) which only code/decode data of a single format. If a computer system needs to process data with different formats using multiple CODEC techniques, the development and manufacturing costs of using only one chip to perform this hardware based processing and simultaneously support different CODEC techniques is extremely high. On the other hand, if software-based processing is used to support the different CODEC techniques, the load and efficiency of the computer system will be seriously degraded.

### SUMMARY OF INVENTION

One objective of the claimed invention is therefore to provide an integrated CODEC apparatus and method that controls a CODEC module according to an original data format of incoming data or according to a target data format of outgoing data, to solve the above-mentioned problems.

According to an exemplary embodiment of the claimed invention, an integrated coder/decoder (CODEC) apparatus is disclosed for converting incoming data into outgoing data. The integrated CODEC apparatus comprises a plurality of CODEC modules, each CODEC module for encoding the incoming data to produce the outgoing data or for decoding the incoming data to produce the outgoing data; and a processing unit electrically coupled to the plurality of CODEC modules for controlling at least one of the CODEC modules to convert the incoming data into the outgoing data according to an original data format of the incoming data or according to a target data format of the outgoing data.

According to another exemplary embodiment of the claimed invention, an integrated coder/decoder (CODEC) method is disclosed for converting incoming data into outgoing data. The integrated CODEC method comprises the following steps: (a) providing a plurality of CODEC modules, each CODEC module for encoding the incoming data to produce the outgoing data or for decoding the incoming data to produce the outgoing data; and (b) controlling at least one of the CODEC modules to convert the incoming data into the outgoing data according to an original data format of the incoming data or according to a target data format of the outgoing data.

The claimed invention determines which CODEC modules are required to be controlled according to an original data format of incoming data or according to a target data format of outgoing data, and converts the data format accordingly. It is an advantage of the present invention integrated CODEC apparatus that development costs are low because the integrated CODEC apparatus can be implemented using hardware. Additionally, when the present invention integrated CODEC apparatus uses hardware processing techniques to perform CODEC operations, the efficiency of a system using the integrated CODEC apparatus is not degraded such as is experienced when using software-based operations.

These and other objectives of the claimed invention will no doubt become obvious to those of ordinary skill in the art after reading the following detailed description of the preferred embodiment that is illustrated in the various figures and drawings.

### BRIEF DESCRIPTION OF DRAWINGS

FIG. 1 is a block diagram of an integrated coder/decoder (CODEC) apparatus according to the present invention.

FIG. 2 is an operational flowchart for the integrated CODEC apparatus of FIG. 1 according to the present invention.

### DETAILED DESCRIPTION

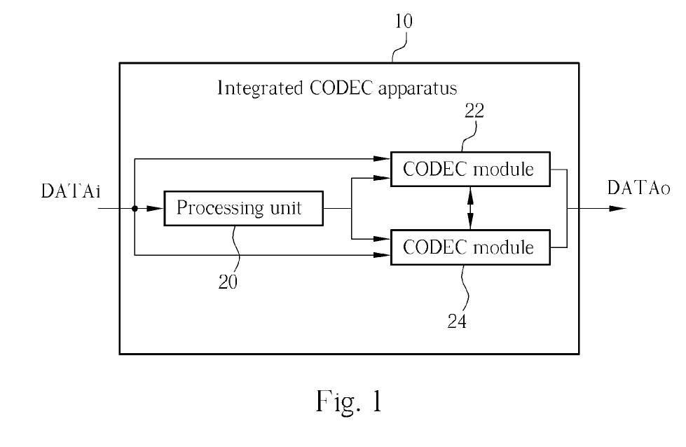

Please refer to FIG. 1. FIG. 1 shows a block diagram of an integrated coder/decoder (CODEC) apparatus 10 according to the present invention. The integrated CODEC apparatus 10 is used to convert incoming data DATAi into outgoing data DATAo. In this embodiment, the integrated CODEC module 10 includes a processing unit 20 and a plurality of CODEC modules 22, 24. It should be noted that although FIG. 1 shows only two CODEC modules 22, 24, the present invention is not limited to a specific number of CODEC modules. The processing unit 20 is electrically connected to the CODEC modules 22, 24 and is used for controlling the operations of the CODEC modules 22, 24. For example, CODEC module 22 is used to convert data corresponding to a first data format into data corresponding to a second data format, and perform a corresponding decoding operation according to the first data format or a corresponding encoding operation according to the second data format. Similarly, CODEC module 24 is used to convert data corresponding to a third data format into data corresponding to a fourth data format, and perform a corresponding decoding operation according to the third data format or a corresponding encoding operation according to the fourth data format. Of course, the data formats used by the CODEC modules 22, 24 could also be converted to one another. For example, when CODEC module 22 outputs data of the second data format to CODEC module 24, CODEC module 24 converts the data of the second data format to the fourth data format, which is then outputted as outgoing data DATAo. Alternatively, when CODEC module 24 outputs data of the fourth data format to CODEC module 22, CODEC module 22 converts the data of the fourth data format to data of the second data format, which is then outputted as outgoing data DATAo.

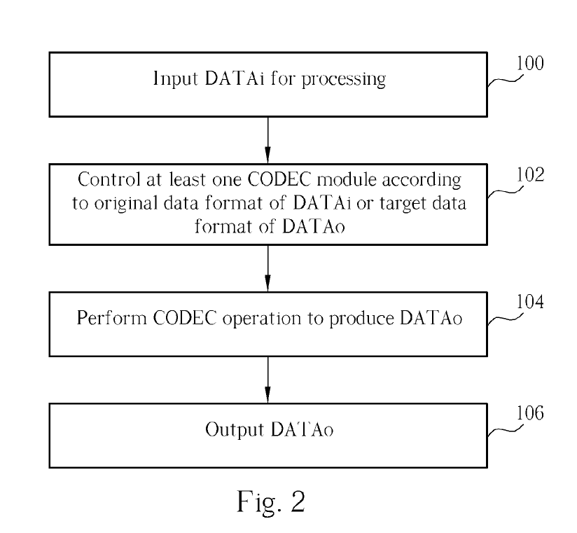

Please refer to FIG. 2. FIG. 2 shows an operational flowchart for the integrated CODEC apparatus 10 shown in FIG. 1 according to the present invention. The operational flowchart for the integrated CODEC apparatus 10 includes the following steps:

Step 100: Input incoming data DATAi for processing.

Step 102: The processing unit 20 controls at least one of the CODEC modules 22, 24 according to the original data format of the incoming data DATAi or a target data format of the outgoing data DATAo.

Step 104: CODEC module 22 or CODEC module 24 performs a CODEC processing operation to produce outgoing data DATAo.

Step 106: Output the processed outgoing data DATAo.

According to the above steps, after the incoming data DATAi is transmitted to the integrated CODEC apparatus 10 (step 100), the processing unit 20 is able to determine the original data format of the incoming DATAi or the desired target data format of the outgoing data DATAo. According to the result of this determination, the processing unit 20 controls the appropriate CODEC module(s) 22, 24 (step 102). For example, if the original data format is the above-mentioned first data format, the processing unit 20 will determine that it is required to control CODEC module 22 to decode the incoming data DATAi to produce outgoing data DATAo corresponding to the above-mentioned second data format (step 104). If the original data format is the above-mentioned third data format, the processing unit 20 will determine that it is required to control CODEC module 24 to decode the incoming data DATAi to produce outgoing data DATAo corresponding to the above-mentioned fourth data format (step 104). If the target data format is the above-mentioned second data format, the processing unit 20 will determine that it is required to control CODEC module 22 to encode the incoming data DATAi to produce outgoing data DATAo corresponding to the above-mentioned second data format (step 104). If the target data format is the above-mentioned fourth data format, the processing unit 20 will determine that it is required to control CODEC module 24 to encode the incoming data DATAi to produce outgoing data DATAo corresponding to the above-mentioned fourth data format (step 104). Finally, by controlling the appropriate CODEC module(s) 22, 24, the integrated CODEC apparatus 10 is able to perform the correct CODEC operation on the incoming data DATAi and properly output the desired outgoing data DATAo (step 106).

Please note that the integrated CODEC apparatus 10 can expand functionality by cascading CODEC modules 22, 24. For example, if the original data format is the first data format and the target data format is the fourth data format, the processing unit 20 controls CODEC module 22 to connect to CODEC module 24. That is, the data outputted by CODEC module 22 becomes the data inputted to CODEC module 24. In this way, the integrated CODEC apparatus 10 receives incoming data DATAi corresponding to the first data format and produces the desired outgoing data DATAo corresponding to the fourth data format. For example, the integrated CODEC module 10 can be used in an encryption/decryption system. In this embodiment, CODEC modules 22, 24 are each used to encrypt raw data to produce the desired decrypted data, or to decrypt encrypted data to produce the raw data. Additionally, the processing unit 20 can simultaneously control CODEC module 22, 24 to produce a cascaded structure. In this organization of CODEC modules 22, 24, it is possible to perform a prearranged encoding operation to encrypt the incoming data DATAi and produce the desired outgoing data DATAo, or to perform a corresponding decryption operation to decrypt the incoming data DATAi and produce the desired outgoing data DATAo.

The integrated CODEC apparatus 10 can also be used in a multimedia processing system. In this embodiment, if CODEC module 22 complies with a first video compression standard (such as MPEG-1, MPEG-2, and MPEG-4), and CODEC module 24 complies with a second video compression standard (such as MPEG-1, MPEG-2, and MPEG-4), then CODEC modules 22, 24 can be used to encode raw data to produce a bit stream compliant with one of the video compression standards or to decode a bit stream compliant with one of the video standards to produce the raw data. In addition, the integrated CODEC apparatus 10 can be used in cascaded organization of the CODEC modules 22, 24 to convert a first bit stream having a first format into another bit stream having a second format. For example, CODEC module 22 can decode a video bit stream according to the MPEG-2 standard, while the CODEC 24 performs a encoding operation according to the MPEG-4 standard. Because of this, if the incoming data DATAi is a video bit stream compliant with the MPEG-2 standard but a user instead wants to obtain a video bit stream compliant with the MPEG-4 standard, the processing unit 20 can simultaneously control CODEC modules 22, 24 to form a cascade structure. In this way, after CODEC module 22 decodes the incoming DATAi and produces the corresponding raw data, the raw data is inputted into CODEC module 24. Next, CODEC module 24 performs an encoding operation on the raw data according to the MPEG-4 standard. Finally, the integrated CODEC apparatus 10 outputs the user desired outgoing data DATAo being compliant with the MPEG-4 standard.

The present invention integrated CODEC apparatus and method determines which CODEC modules are required according to an original data format of incoming data or a target data format of outgoing data. Because the present invention integrated CODEC apparatus can be implemented using hardware, the development costs are low. Additionally, when the present invention CODEC apparatus uses hardware processing techniques to perform CODEC operations, this avoids degrading the efficiency of the system as is experienced when using software based operations.

Those skilled in the art will readily observe that numerous modifications and alterations of the device may be made while retaining the teachings of the invention. Accordingly, the above disclosure should be construed as limited only by the metes and bounds of the appended claims.

1. An integrated coder/decoder (CODEC) apparatus for converting incoming data into outgoing data, the integrated CODEC apparatus comprising:
a plurality of CODEC modules, each CODEC module for encoding the incoming data to produce the outgoing data or for decoding the incoming data to produce the outgoing data; and
a processing unit electrically coupled to the plurality of CODEC modules for controlling at least one of the CODEC modules to convert the incoming data into the outgoing data according to an original data format of the incoming data or according to a target data format of the outgoing data.

2. The integrated CODEC apparatus of claim 1, wherein a first CODEC module is used for converting data of a first data format into data of a second data format, and a second CODEC module is used for converting data of a third data format into data of a fourth data format.

3. The integrated CODEC apparatus of claim 2, wherein if the processing unit determines the original data format to be the first data format or determines the target data format to be the second data format, the processing unit controls the first CODEC module to convert the incoming data to the outgoing data; and if the processing unit determines the original data format to be the third data format or determines the target data format to be the fourth data format, the processing unit controls the second CODEC module to convert the incoming data to the outgoing data.

4. The integrated CODEC apparatus of claim 3, wherein the first CODEC module performs a decoding operation according to the first data format, the first CODEC module performs an encoding operation according to the second data format, the second CODEC module performs a decoding operation according to the third data format, and the second CODEC module performs an encoding operation according to the fourth data format.

5. The integrated CODEC apparatus of claim 2, wherein the second CODEC module is cascaded with the first CODEC module, and if the processing unit determines the original data format is the first data format and the target data format is the fourth data format, the processing unit controls the first and second CODEC modules to convert the incoming data to the outgoing data.

6. The integrated CODEC apparatus of claim 5, wherein the first CODEC module performs a decoding operation according to the first data format, and the second CODEC module performs a decoding operation according to the third data format.

7. The integrated CODEC apparatus of claim 5, wherein the first CODEC module performs a decoding operation according to the first data format, and the second CODEC module performs an encoding operation according to the fourth data format.

8. The integrated CODEC apparatus of claim 5, wherein the first CODEC module performs an encoding operation according to the second data format, and the second CODEC module performs an encoding operation according to the fourth data format.

9. The integrated CODEC apparatus of claim 1, wherein the original data format or the target data format complies with the Moving Picture Experts Group (MPEG) standard.

10. An integrated coder/decoder (CODEC) method for converting incoming data into outgoing data, the integrated CODEC method comprising the following steps:
(a) providing a plurality of CODEC modules, each CODEC module for encoding the incoming data to produce the outgoing data or for decoding the incoming data to produce the outgoing data; and
(b) controlling at least one of the CODEC modules to convert the incoming data into the outgoing data according to an original data format of the incoming data or according to a target data format of the outgoing data.

11. The integrated CODEC method of claim 11, wherein step (a) further comprises providing a first CODEC module for converting data of a first data format into data of a second data format, and providing a second CODEC module for converting data of a third data format into data of a fourth data format.

12. The integrated CODEC method of claim 11, wherein if the original data format is the first data format or the target data format is the second data format, controlling the first CODEC module to convert the incoming data to the outgoing data; and if the original data format is the third data format or the target data format is the fourth data format, controlling the second CODEC module to convert the incoming data to the outgoing data.

13. The integrated CODEC method of claim 12, wherein the first CODEC module performs a decoding operation according to the first data format, the first CODEC module performs an encoding operation according to the second data format, the second CODEC module performs a decoding operation according to the third data format, and the second CODEC module performs an encoding operation according to the fourth data format.

14. The integrated CODEC method of claim 11, wherein the second CODEC module is cascaded with the first CODEC module, and the method further comprises if the original data format is the first data format and the target data format is the fourth data format, controlling the first and second CODEC modules to convert the incoming data to the outgoing data.

15. The integrated CODEC method of claim 14, wherein the first CODEC module performs a decoding operation according to the first data format, and the second CODEC module performs a decoding operation according to the third data format.

16. The integrated CODEC method of claim 14, wherein the first CODEC module performs a decoding operation according to the first data format, and the second CODEC module performs an encoding operation according to the fourth data format.

17. The integrated CODEC method of claim 14, wherein the first CODEC module performs a encoding operation according to the second data format, and the second CODEC module performs an encoding operation according to the fourth data format.

18. The integrated CODEC method of claim 10, wherein the original data format or the target data format complies with the Moving Picture Experts Group (MPEG) standard.
